(19) United States
(12) Patent Application Publication
(10) Pub. No.: US 2003/0023765 A1
(43) Pub. Date: Jan. 30, 2003

(54) Method for controlling a plurality of units interconnected in a ring network and ring network

(76) Inventors: Hans-Peter Goelz, Schonau (DE); Tien Manh Tran, Zweibrucken (DE); Stefan Beckers, Vaihingen/Enz (DE); Thomas Romanowski, Karlsruhe (DE)

Correspondence Address: Samuels, Gauthier & Stevens LLP, Suite 3300, 225 Franklin Street, Boston, MA, 02110, US

(21) Appl. No.: 10/171,418

(22) Filed: Jun. 13, 2002

(30) Foreign Application Priority Data
Jun. 13, 2001 (DE) 101 28 542.6

(51) Int. Cl. G06F 15/16

(52) U.S. Cl. 709/251; 709/218

(57) ABSTRACT

For a multimedia ring network (A) interconnecting a plurality of units (B), for example built into a vehicle, to be adapted automatically to expansions or reductions with respect to the unite (B), there is a unit serving as the man/machine interface (C), which is built up from an application plane (A⁴), an interface (E), an access plane (F), a data plane (G), a transmitting and receiving unit (H), a function catalog (I) and a program generator (J). Commands input by a user into the application plane (D) are converted to data telegrams in the data plane (E) and fed into the network (A) by the transmitting and receiving unit (H). The addressed units (B) transmit reply telegrams back to the man/machine interface (C), where they are visually displayed in the application plane (D) for the user. The program generator generates the programs belonging to the functions of the network described in the function catalog (I) and transmits them to the interface (E), to the access plane (F) or to the data plane (G).

This invention relates to a method for controlling a plurality of units interconnected in a ring network.

The invention further relates to a ring network interconnecting a plurality of units.

Multimedia networks in which a plurality of units such as for example a radio receiver, television receiver, CD player, DVD player, cassette device, or navigation device, interconnected via an optical ring data bus, are built into vehicles. When an additional device, for example a car telephone, is linked to the network, the programs needed for operating this new unit are manually input into the multimedia network, which requires a time-consuming stay of the vehicle in a shop as well as the employment of trained personnel.

It is therefore an goal of the invention to create a ring network, in particular a multimedia network for a vehicle, such that reconfigurations and expansions of the network are greatly simplified.

In terms of method, this goal is achieved with the features listed in Claim 1.

In terms of device, this goal is achieved with the features listed in Claim 2.

The network according to the invention interconnects a plurality of units in ring fashion. One of these units serves as a man/machine interface. This unit is built up from an application plane, an interface, a data plane, a transmitting and receiving plane, a function catalog and a program generator.

The application plane serves for the input of commands by a user and for the display of information received from the network.¹ The interface connects the application plane to the access plane, in which the commands input by the user into the application plane are converted for the data plane, in which data telegrams associated with the input commands are generated and information received from the network is forwarded to the application plane for display.

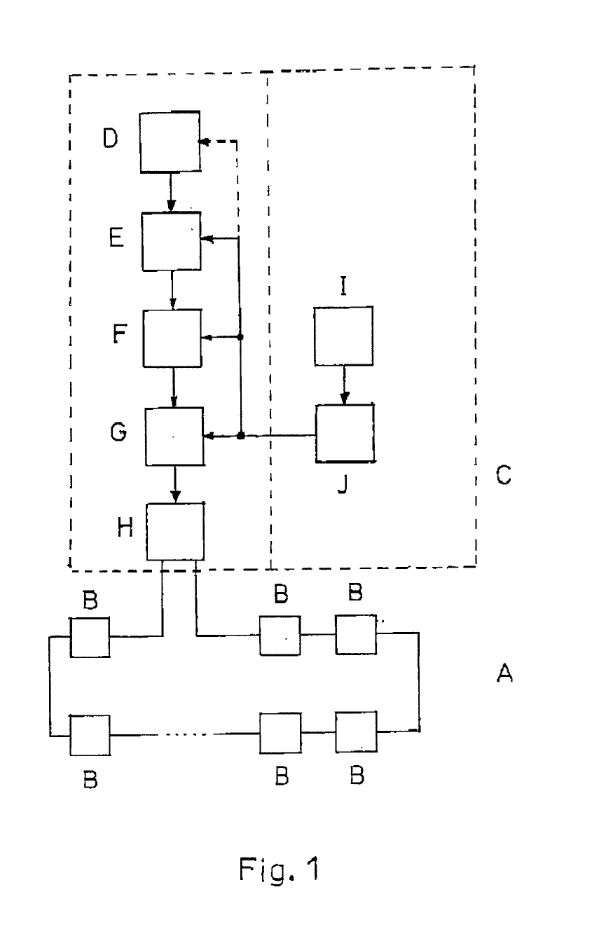

¹I have consistently read “vom Netzwerk” as from, not by, the network. I believe the interpretation is supported by FIG. 1, where the network A appears to get information from C and return information to C but C is not treated as part of the network.—Translator's Note.

The transmitting and receiving plane feeds the data telegrams generated by the data plane into the network and receives data telegrams from the network, forwarding them to the data plane, which forwards the data telegrams to the application plane, where they are displayed to the user, for example visually.

The function catalog, in which the functions of the network are described, controls the program generator, which generates the programs for the various functions and makes them available to the interface, the access plane, and the data plane.

Upon expansion or reduction of the units of the network, the function catalog and the program generator can be linked to the interface, the access plane, and the data plane. The function catalog and the program generator can also, however, be permanently integrated into the man/machine interface. In addition to the functions of the network, the applications of the application plane can also be described in the function catalog.

For example, the network is a multimedia network built into a vehicle, the units of the network being interconnected in ring fashion via an optical bus.

One of the units interconnected in the multimedia network can be, for example, a radio receiver. The user can, for example, input his favorite station or his favorite program into the application plane, whereon a data telegram is generated in the data plane and transmitted by the transmitting and receiving unit to the radio receiver. This favorite station or this favorite program is stored in the radio receiver. The radio receiver transmits a reply telegram to the unit used as the man/machine interface, where the reply telegram is received by the transmitting and receiving plane and forwarded to the data plane. The data plane transmits the reply telegram to the application plane, where the name of the selected favorite station or of the selected favorite program is displayed to the user.

The invention is described more fully and explained on the basis of the figures.

In the drawings:

FIG. 1 is a block diagram of an embodiment of the invention,

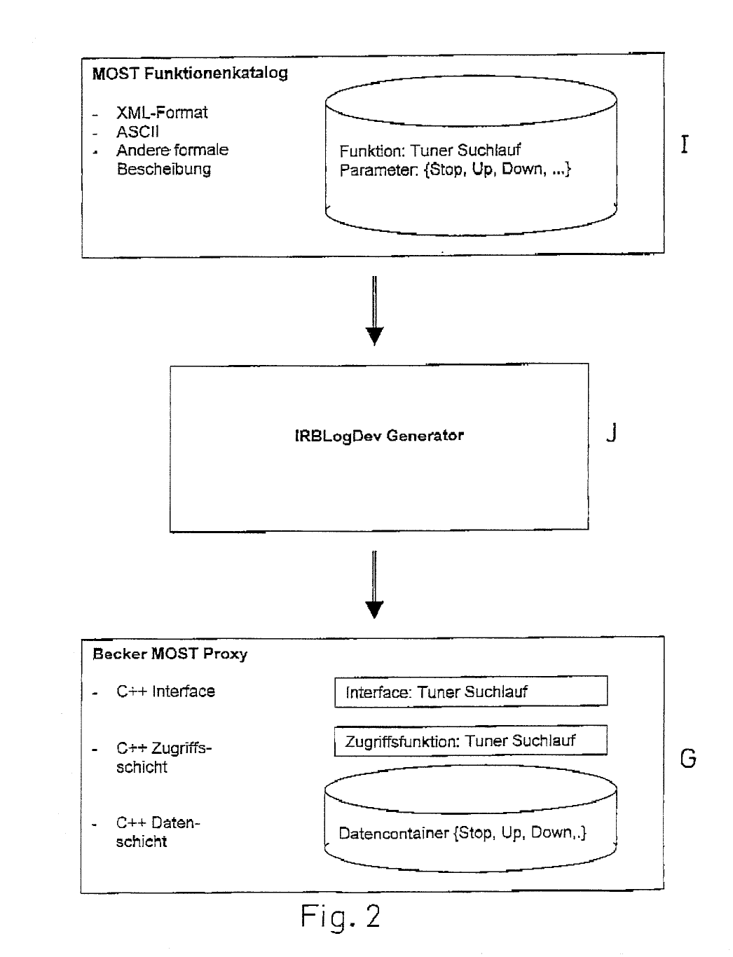

FIG. 2 is a block diagram of the function catalog, the program generator, and the data plane of the embodiment,

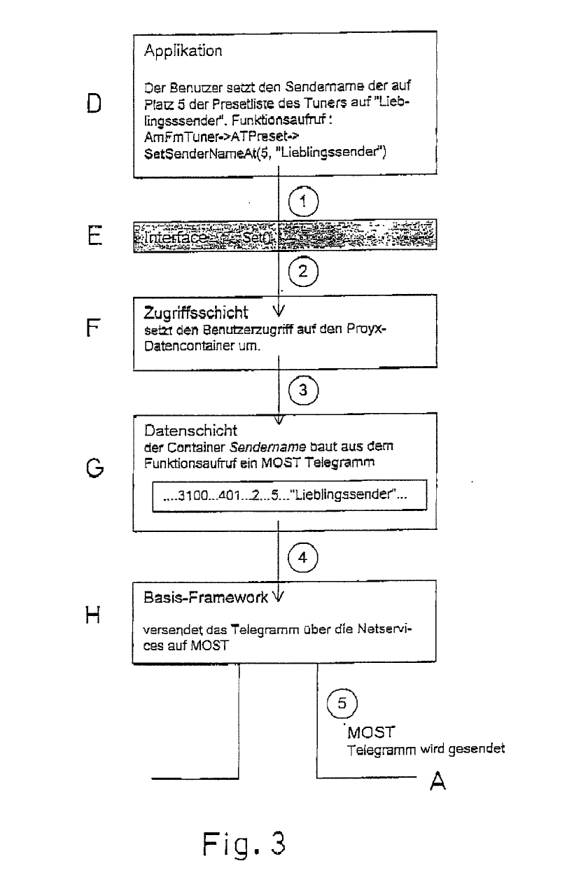

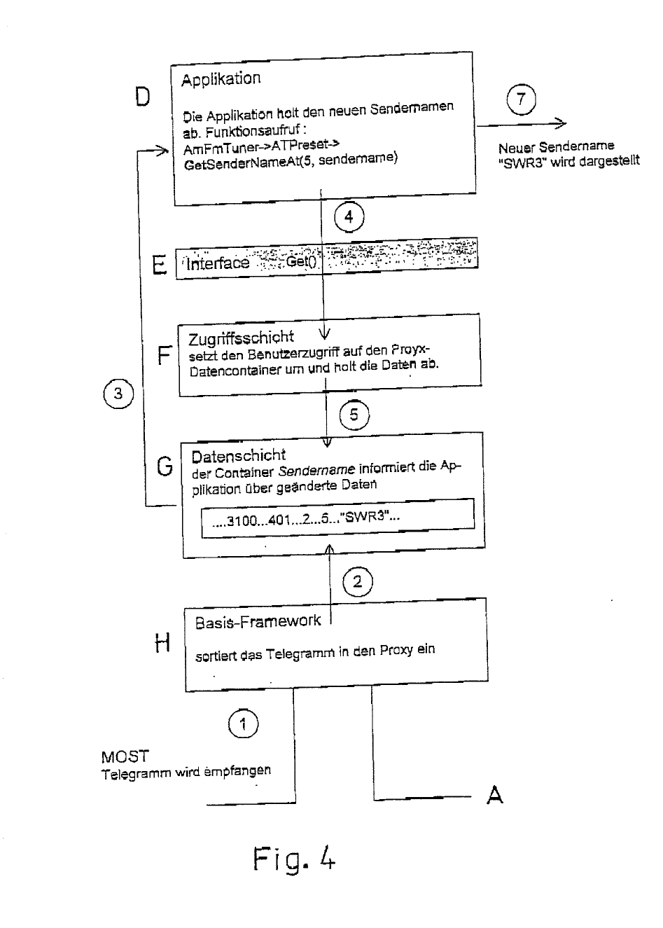

FIGS. 3 and 4 are flowcharts representing the selection of a preferred station or program.

FIG. 1 shows an embodiment of a ring network according to the invention, in which a plurality of units B and a unit C serving as the man/machine interface are interconnected. In unit C, provided as the man/machine interface, an application plane D is connected via an interface E to an access plane F, which is connected to a data plane G. Data plane G is linked to network A via a transmitting and receiving unit H. A function catalog I is connected to a program generator J, which is linked to interface E, access plane F, and data plane G. Function catalog I and program generator J can be linked to interface E, access plane F, and data plane G as referred to above. Alternatively, however, function catalog I and program generator J can also be integrated into man/machine interface C. In addition to the functions of network A, the applications of application plane D can also be described in function catalog I

A command input by the user into application plane D is forwarded via interface E to access plane F, where the command is converted for data plane G. In data plane G, a data telegram associated with the command input by the user is generated and sent to transmitting and receiving unit H, which feeds the data telegram into network A, where it is received by the chosen unit and answered in the form of a reply telegram, which transmitting and receiving unit H receives and forwards to data plane G, which forwards it to application plane D, where the information contained in the reply telegram is displayed to the user, for example visually.

The forwarding of a command input to the application plane is explained on the basis of the flowchart shown in FIGS. 3 and 4.

The user defines a station or a program as the preferred station or preferred program in application plane D. Via interface plane E, the command input by the user into application plane D and the name of the preferred station or program are sent to access plane F, where the command and the name are converted for data plane G. In data plane G, which represents for example a proxy data container, a data telegram is generated, which is fed into network A via transmitting and receiving plane H and transmitted to the radio receiver. The name input by the user into application plane D is stored as the preferred station or preferred program in the radio receiver. Via network A, the radio receiver now transmits a reply telegram, which is received by transmitting and receiving plane H and forwarded to data plane G. The name of the station or program designated as preferred in the radio receiver is transmitted by data plane G to application plane D, where the name, for example SWR3, is displayed visually for the user.

FIG. 2 shows function catalog I, program generator J, and data plane G of the embodiment shown in FIG. 1.

The functions stored in function catalog I can be stored for example in XML format or in ASCII format. An example of a function is the tuner search function of the radio receiver.

Data plane G can be designed, for example, as a proxy data container.

By the practice according to the invention of storing the functions of the network in a function catalog and generating the programs associated with the various functions stored in the function catalog in a program generator, and feeding them into the network, the network is automatically adapted to expansions with additional units or to reduction of the units by the removal of units. Manual input of commands in a shop is no longer necessary because all the functions of the network are stored in the function catalog. The network according to the invention automatically detects the insertion or removal of a unit as well as the unit concerned.

### LIST OF REFERENCE SYMBOLS

| | |
|---|---|
| A | Network |
| B | Unit |
| C | Man/machine interface |
| D | Application plane |
| E | Interface |
| F | Access plane |
| G | Data plane |
| H | Transmitting and receiving unit |
| I | Function catalog |
| J | Program generator |

1. Method for controlling a plurality of units (B) interconnected in a ring network (A), having a unit serving as the man/machine interface (C), having an application plane (D) for the input of commands by a user and for the display of information received from the network (A), having an interface (E) that connects the application plane (D) to an access plane (F) in which the commands input by the user into the application plane (D) are converted and transmitted to a data plane (G) in which data telegrams are generated and which forwards information received from the network (A) to the application plane (D) for display, having a transmitting and receiving plane (H) that feeds the data telegrams generated by the data plane (G) into the network (A) and forwards data telegrams received from the network (A) to the data plane (G), having a function catalog (I) in which the functions of the network (A) are described, and having a program generator (J) that generates the programs for the various functions and transmits them to the interface (E), to the access plane (F), or to the data plane (G).

2. Ring network (A) interconnecting a plurality of units (B), having a unit provided as the man/machine interface (C), having an application plane (D) for the input of commands by a user and for the display of information received from the network (A), having an interface (E) by which the application plane (D) is connected to an access plane (F) in which the commands input by the user into the application plane (D) can be converted and forwarded to a data plane (G) in which data telegrams can be generated and by which information received from the network (A) can be forwarded to the application plane (A²) for display, having a transmitting and receiving plane (A³) by which the data telegrams generated by the data plane (G) can be fed into the network (A) and data telegrams received from the network (A) can be forwarded to the data plane (G), having a function catalog (I) in which the functions of the network (A) are described, and having a program generator (J) for generating the programs for the various functions for the interface (E), the access plane (F), or the data plane (G).
²Sic. The application plane is (D).—Translator's Note.
³Sic. The transmitting and receiving plane is (H)—Translator's Note.

3. Method according to claim 1 or network according to claim 2,
characterized in that, upon expansion or reduction of the units (B) of the network (A), a link is effected or exists between the function catalog (I) and the program generator (J) on the one hand and the interface (E), the access plane (F), or the data plane (G) on the other hand.

4. Method according to claim 1 or network according to claim 2,
characterized in that integration of the function catalog (I) and the program generator (J) into the man/machine interface (C) is effected or exists.

5. Method or network according to claim 4,
characterized in that description of the applications of the application plane (D) in the function catalog (I) is effected or exists.

6. Method according to one of claims 1 to 5,
characterized in that provision for a multimedia network is made or exists for the network.

7. Method or network according to claim 6,
characterized in that incorporation of the multimedia network (A) into a vehicle is effected or exists.

8. Method or network according to one of claims 1 to 7,
characterized in that interconnection of the units (B, C) of the network (A) via an optical bus is effected or exists.

9. Method or network according to claim 7 or 8,
characterized in that provision for at least one radio receiver in the network (A) is made or exists.

10. Method or network according to one of claims 1 to 9,
characterized in that description of the functions stored in the function catalog (I) in XML format, ASCII format, or other format is effected or exists.

11. Method or network according to claim 9 or 10,
characterized in that a command for the storage of the name of a selectable station or program is input or can be input into the application plane (D) by the user, that the input command is transmitted or can be forwarded via the interface (E) to the access plane (F), where the command is converted or can be converted for the data plane (G), that a data telegram associated with the command is generated or can be generated in the data plane (G), which data telegram is fed or can be fed into the network (A) by the transmitting and receiving unit (H), that the data telegram is received or can be received by the radio receiver, that the radio receiver, pursuant to the command, feeds the name of the selected station or
program into the network (A) as a reply telegram or that the name of the selected station or program can be fed by the radio receiver, pursuant to the command, into the network (A) as a reply telegram, that the transmitting and receiving unit (H) receives the reply telegram and forwards it to the data plane (G), which forwards it to the application plane (D), where the name of the selected station or program is displayed, or that the reply telegram can be received by the transmitting and receiving unit (H) and can be forwarded to the data plane (G), whence it can be forwarded to the application plane (D), where the name of the selected station or program can be displayed.

12. Method or network according to claim 9, 10 or 11,
characterized in that description of the tuner search function of the radio receiver is effected or exists as a function in the function catalog (I).
